(19) United States
(12) Patent Application Publication
(10) Pub. No.: US 2014/0285495 A1
(43) Pub. Date: Sep. 25, 2014

(54) Apparatus and Method for Generating Font by Using Glyph Interpolation

(71) Applicant: Hanyang Information & Communications Co., Ltd., Seoul (KR)

(72) Inventor: Kyung Soo Kang, Seoul (KR)

(73) Assignee: HANYANG INFORMATION & COMMUNICATIONS CO., LTD., Seoul (KR)

(21) Appl. No.: 14/350,721

(22) PCT Filed: Jun. 20, 2013
(86) PCT No.: PCT/KR2013/005435

§ 371 Date: Apr. 9, 2014

(30) Foreign Application Priority Data
Jun. 21, 2012 (KR) 10-2012-0066984

(51) Int. Cl. G06T 11/60

(52) U.S. Cl. CPC G06T 11/60
USPC 345/471

(57) ABSTRACT

An apparatus and method for generating a font by using a glyph is provided. The method includes: generating a first basic glyph as a basic shape of a character or a grapheme; generating second through a^{th} (wherein a is an integer greater than or equal to 2) basic glyphs to which at least one of a transversely expanded shape of the basic shape and a longitudinally expanded shape of the basic shape is applied; performing an interpolation operation by using at least two of the first through a^{th} basic glyphs to generate an interpolation glyph having a different shape from the first through a^{th} basic glyphs; and generating a font by using the first through a^{th} basic glyphs and the interpolation glyph.

### TECHNICAL FIELD

The present invention relates to a method of generating and rendering font, and more particularly, to a method of generating and rendering a font by using glyph interpolation

### BACKGROUND ART

A glyph that indicates a shape of a character is required to express the character by using a font. The glyph indicates detailed shape, design, expression, etc. of the character and also indicates a particular graphic expression of an element of a language such as a particular font or grapheme, or the like.

For example, a font for displaying Hangul characters or the like requires a large number of glyphs. If a font is formed by using a grapheme combination method, a shape of the font varies according to how to combine respective graphemes in one character, and a plurality of glyphs are required to express the graphemes. For example, a total of 11,172 combinable characters are multiplied by three cases reflecting an initial consonant, a medial vowel, and a final consonant to form a total of 33,615 grapheme glyphs. As a method of reducing the number of grapheme glyphs, an attempt to classify the grapheme glyphs into a plurality of groups and form only between 2000 and 4000 glyphs in order to reduce the number of grapheme glyphs is provided.

However, even in this case, there is a large number of glyphs of similar graphemes to be formed. Therefore, a large amount of time is taken to form glyphs, and consistency between grapheme glyphs is lowered.

### DETAILED DESCRIPTION OF THE INVENTION

### Technical Problem

The present invention provides a method of generating and rendering a font by using glyph interpolation, by which glyphs are efficiently generated to improve consistency between grapheme glyphs and glyph generation efficiency.

### Technical Solution

According to an aspect of the present invention, there is provided a method of generating a font. The method may include: generating a first basic glyph as a basic shape of a character or a grapheme; generating second through a^{th} (wherein a is an integer greater than or equal to 2) basic glyphs to which at least one of a transversely expanded shape of the basic shape and a longitudinally expanded shape of the basic shape is applied; performing an interpolation operation by using at least two of the first through a^{th} basic glyphs to generate an interpolation glyph having a different shape from the first through a^{th} basic glyphs; and generating a font by using the first through a^{th} basic glyphs and the interpolation glyph.

The method may further include: analyzing information of characters of which the font is realized. At least two of the first through a^{th} basic glyphs may be selected according to a result of the analyzing to perform the interpolation operation in order to generate the interpolation glyph.

The second through a^{th} basic glyphs may include second through fourth basic glyphs. The second glyph may be a transversely expanded glyph of the basic shape, the third basic glyph may be a longitudinally expanded glyph of the basic shape, and the fourth basic glyph may be at least one of a transversely expanded glyph of the basic glyph and a longitudinally expanded glyph of the basic glyph.

According to an aspect of the present invention, there is provided an apparatus for generating a font. The apparatus may include: a font generator which generates a font by using a plurality of glyphs; and a glyph generator which pre-generates a plurality of basic glyphs for realizing the font and performs an interpolation operation with respect to two basic glyphs selected from the plurality of basic glyphs to generate interpolation glyphs having different shapes from the basic glyphs. The font generator may generate the font by using at least one of the pre-generated basic glyphs and the interpolation glyphs generated by the interpolation operation.

### Advantageous Effects

According to the present invention as described above, various shapes of glyphs may be generated by using only a smaller number of glyphs. Therefore, the number of glyphs included in a font may be reduced to reduce a storage space for storing the font and reduce a font transmission amount. Also, a time taken to form the glyphs may be reduced.

### DESCRIPTION OF THE DRAWINGS

FIG. 1 is a block diagram illustrating a general glyph set of a grapheme.

FIG. 2 is a block diagram illustrating a glyph set of a grapheme according to an embodiment of the present invention.

FIG. 3 is a view illustrating an interpolation operation for generating various shapes of glyphs, according to an embodiment of the present invention.

FIG. 4 is a view illustrating an interpolation operation for generating various shapes of glyphs, according to another embodiment of the present invention.

FIGS. 5A and 5B are block diagrams illustrating an apparatus for generating a font according to an embodiment of the present invention.

FIG. 6 is a flowchart illustrating a method of operating a font generating apparatus according to an embodiment of the present invention.

FIGS. 7A through 7D are views illustrating a user interface that uses a bounding box to generate an interpolation glyph, according to an embodiment of the present invention.

FIG. 8 is a block diagram illustrating an apparatus for generating a font, according to another embodiment of the present invention.

FIG. 9 is a block diagram illustrating a web font system according to an embodiment of the present invention.

FIG. 10 is a flowchart illustrating a method of generating a glyph according to another embodiment of the present invention.

FIG. 11 is a flowchart illustrating method of generating a glyph, according to another embodiment of the present invention.

### BEST MODE

The attached drawings for illustrating embodiments of the present invention are referred to in order to gain a sufficient understanding of the present invention, the merits thereof, and the objectives accomplished by the implementation of the present invention.

Hereinafter, the present invention will be described in detail by explaining embodiments of the invention with reference to the attached drawings. Like reference numerals in the drawings denote like elements.

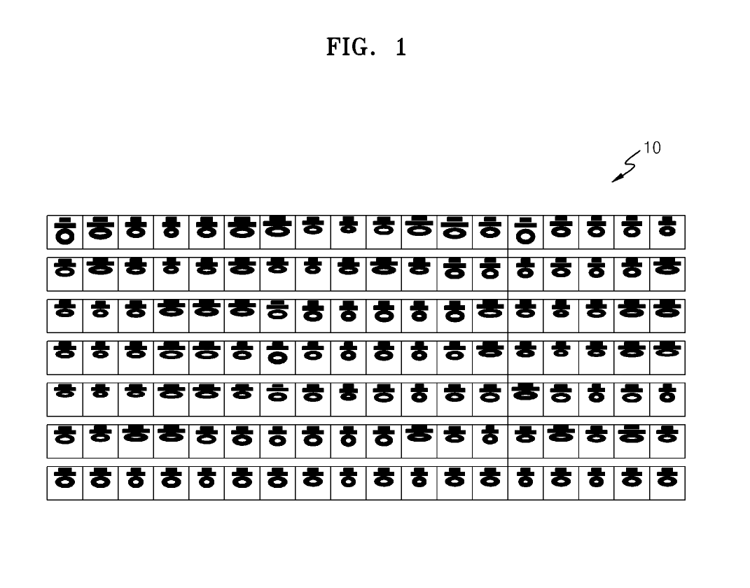

FIG. 1 is a block diagram illustrating a general glyph set of a grapheme. As shown in FIG. 1, characters that may be realized by one font may have various shapes. For example, if one character is realized through a combination of one or more graphemes like in the case of Hangul, glyphs are required for an initial consonant, a medial vowel, and a final consonant with respect to each grapheme. Also, various shapes of glyphs are required according to which medial vowel and final consonant which one initial consonant is combined with.

For example, FIG. 1 illustrates an example of a plurality of glyphs that are generated to correspond to a grapheme “ [symbol] ”. As shown in FIG. 1, a plurality of similar glyphs are generated and included in a font generating apparatus. Also, one of a plurality of glyphs that are respectively stored for characters expressed by the font is selected to generate a font of a corresponding character. However, according to this method, there is a limit in generating similar glyphs. Although a font to which the above-described glyphs are applied is generated, it is difficult to express a detailed character according to the corresponding font.

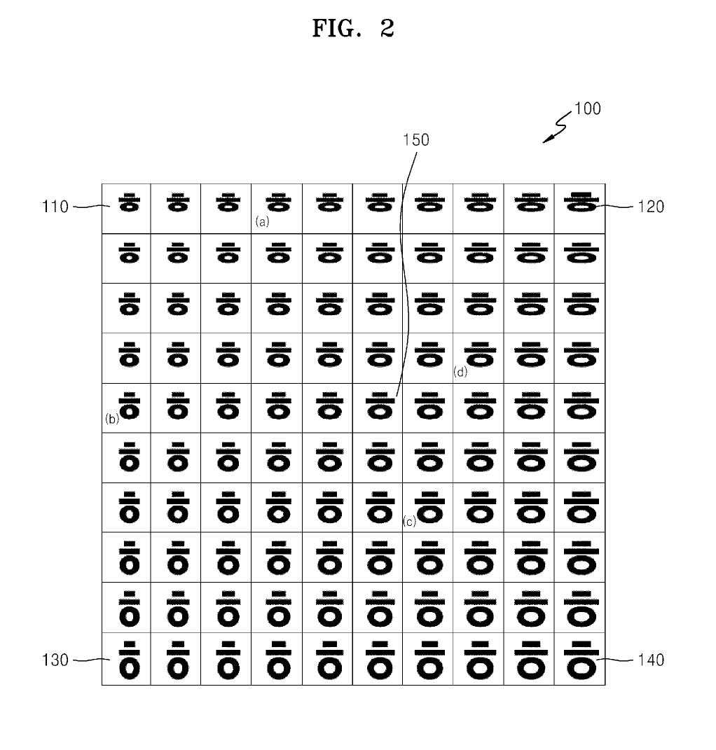

FIG. 2 is a block diagram illustrating a glyph set 100 of a grapheme according to an embodiment of the present invention.

As shown in FIG. 2, according to the present embodiment, a preset number of basic glyphs are applied to one grapheme. The glyph set 100 of FIG. 2 includes a plurality of glyphs corresponding to “ [symbol] ”, which is one grapheme of Hangul. Three or more basic glyphs of the glyph set 100 of FIG. 2 may be pre-generated and pre-stored. For example, four basic glyphs 110, 120, 130, and 140 may be pre-generated and then pre-stored in a font generating apparatus.

In Hangul, consonant graphemes “ [symbol] ”, “ [symbol] ”, and “ [symbol] ” may form three designs of a transverse gathering character, a longitudinal gathering character, and a final consonant, and initial consonant graphemes may form two designs of a transverse gathering character and a longitudinal gathering character and one design “ [symbol] ” or the like. A vowel grapheme may form two designs with final consonants and two designs with no final consonants. In this case, a total of only 21*2+19*2 (about 80) basic glyphs may be designed. Also, the basic glyphs may include 80 transversely expanded basic glyphs, 80 longitudinally expanded basic glyphs, and 80 transversely and/or longitudinally expanded basic glyphs to design a total of 320 basic glyphs. All shapes of glyphs that will be used for 11,172 characters of Hangul may be generated by using basic glyphs designed as described above. All of the shapes of the glyphs may be generated by an interpolation operation using 320 basic glyphs that will be described later.

Referring to FIG. 2 again, the four basic glyphs 110 through 140 are generated and stored in a system to correspond to the grapheme “ [symbol] ”. The four basic glyphs 110 through 140 may be stored as they are to realize a font or may be stored to generate other shapes of glyphs by using the four basic glyphs 110 through 140. Among the four basic glyphs 110 through 140, the first basic glyph 110 may correspond to a basic shape of glyph, the second basic glyph 120 may be a transversely expanded glyph of the first basic glyph 110, the third basic glyph 130 may be a longitudinally expanded glyph of the first basic glyph 110, and the fourth basic glyph 140 may be a transversely and/or longitudinally expanded glyph of the first basic glyph 110.

The four basic glyphs 110 through 140 may have coordinate information for expressing an actual character so that the actual character has a corresponding glyph shape. Therefore, in comparison with the first basic glyph 110, the second basic glyph 120 may have coordinate information for expressing a character that has the same thickness but is expanded in a transverse direction. Similarly, the third basic glyph 130 may have coordinate information for forming a character that is longitudinally expanded, and the fourth basic glyph 140 may have coordinate information for expressing a character that is transversely and longitudinally expanded.

In the glyph set 100 of FIG. 2, only the first through fourth basic glyphs 110 through 140 may be pre-generated and stored in the font generating apparatus, and the other glyphs may be generated by using at least one of the first through fourth basic glyphs 110 through 140. For example, a glyph shown with (a) is a glyph that is expanded in a transverse direction and that may be generated by using interpolation operations of the first and second basic glyphs 110 and 120. In other words, when generating a font for expressing each character or grapheme, a shape of a glyph for expressing each grapheme may be changed. If the grapheme “ [symbol] ” is expressed according to the glyph of (a), the first and second basic glyphs 110 and 120 may be interpolated to generate the glyph of (a). Since the glyph of (a) is generated by interpolating the first and second basic glyphs 110 and 120, the glyph of (a) may have coordinate information that is generated according to a result of an operation performed on the coordinate information of the first basic glyph 110 and the coordinate information of the second basic glyph 120.

If the grapheme “ [symbol] ” is expressed according to a glyph of (b), the first and third basic glyphs 110 and 130 may be interpolated to generate the glyph of (b). The glyph of (b) is a glyph having a shape between a basic glyph of the grapheme “ [symbol] ” and a longitudinally expanded basic glyph of the grapheme “ [symbol] ”. An operation may be performed on the coordinate information of the first basic glyph 110 and the coordinate information of the third basic glyph 130 to calculate coordinate information for expressing the glyph of (b). Also, if the grapheme “ [symbol] ” is expressed according to the glyph of (c), the first and fourth basic glyphs 110 and 140 may be interpolated to generate the glyph of (c).

If the grapheme “ [symbol] ” is expressed according to the glyph of (d), the first through third basic glyphs 110 through 130 may be interpolated to generate the glyph of (d). For this, the first and second basic glyphs 110 and 120 may be interpolated to generate an appropriately transversely expanded glyph, and the appropriately transversely expanded glyph may be interpolated into the third basic glyph 130 to generate the glyph of (d). In other words, an operation may be performed on the coordinate information of the first through third basic glyphs 110 through 130, and coordinate information for expressing the glyph of (d) may be generated according to a result of the operation.

Glyphs of FIG. 2 described above may be glyphs of one grapheme, i.e., may be referred to as single glyphs. In other words, the glyphs may include the first through fourth glyphs 110 through 140 and glyphs that are generated by interpolating at least two of the first through fourth basic glyphs 110 through 140. Also, when generating the glyphs, a combined glyph into which at least two graphemes are combined may be generated. For example, an interpolation operation may be performed based on basic glyphs of each grapheme, and two or more single glyphs may be combined to generate the combined glyph.

As described above, only some basic glyphs are pre-stored in the font generating apparatus, and an interpolation operation may be performed between basic glyphs of characters expressed by a corresponding font to generate various shapes of glyphs. Therefore, a font by which a character may be expressed in various shapes may be realized without generating and storing a large number of glyphs. According to a glyph generating method as described above, when a font is developed, a time taken to form the font may be drastically reduced, and a large number of high quality fonts may be formed.

In the above-described embodiment, only glyphs including one font have been described. However, embodiments of the present invention are not limited thereto. For example, the font generating apparatus may generate a plurality of fonts, and a glyph generating method according to an embodiment of the present invention may be applied to each of the plurality of fonts.

Also, in the above-described embodiment, besides basic glyphs, a glyph (an interpolation glyph) is generated by an interpolation operation in a system. However, a user interface for generating an actual glyph may be provided as a graphic tool such as a bounding box or the like. For example, a bounding box for each grapheme may be provided, drag information of the bonding box may be input by a user, and an interpolation operation may be performed based on the input drag information to generate an interpolation glyph.

In the glyph set of FIG. 2, an interpolation operation may be performed based on a plurality of pieces of coordinate information with respect to each glyph not based on a line (or a border) of a glyph. Therefore, a thickness between a basic glyph and an interpolation glyph may be substantially the same or may be expanded or reduced within a limit of generating a glyph having an appropriate shape. In other words, if a modified glyph is generated through an adjustment such as expansion and/or reduction or the like performed with respect to a glyph, a thickness of the glyph may be overly thinned or thickened, and thus glyphs inappropriate for generating a font may be generated.

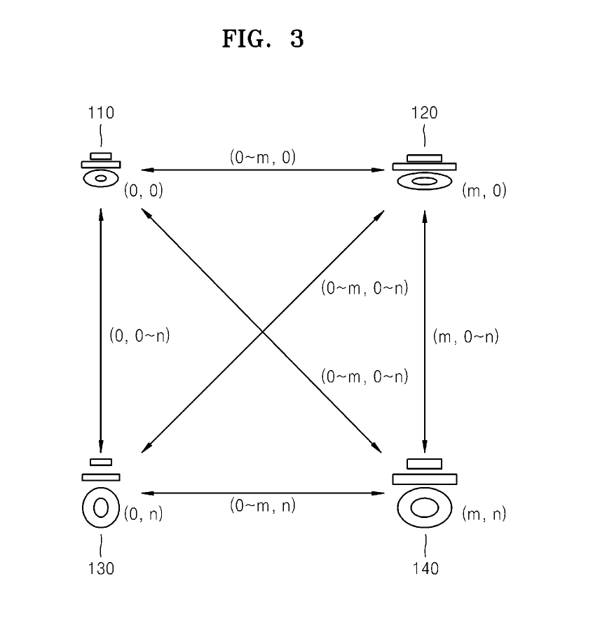

FIG. 3 is a view illustrating an interpolation operation for generating glyphs of various shapes, according to an embodiment of the present invention. As shown in FIG. 3, four basic glyphs are provided to correspond to one grapheme. A first basic glyph 110 is a basic glyph, a second basic glyph 120 is a transversely expanded glyph of the basic glyph, a third basic glyph 130 is a longitudinally expanded glyph of the basic glyph, and a fourth basic glyph 140 is a transversely and/or longitudinally expanded glyph of the basic glyph. (m+1)*(n+1) glyphs may be generated by an interpolation operation using the first through fourth basic glyphs 110 through 140.

Here, a position of the first basic glyph 110 may be defined as (0, 0), a position of the second basic glyph 120 may be defined as (m, 0), a position of the third basic glyph 130 may be defined as (0, n), and a position of the fourth basic glyph 140 may be defined as (m, n). Each of the first through fourth basic glyphs 110 through 140 may include coordinate information for expressing a character according to corresponding shapes.

In order to realize a font, combination forms of respective graphemes in a character may be analyzed to select a glyph for expressing the grapheme. For example, if a grapheme is expressed by one of the basic glyphs, a font of the corresponding may be realized by using the corresponding basic glyph without an additional interpolation operation. If the corresponding grapheme is expressed according to another glyph not among the basic glyphs, a necessary glyph may be generated by an interpolation operation using basic glyphs, and the font of the corresponding grapheme may be realized by using the necessary glyph.

When generating the necessary glyph, a position of the necessary glyph for transverse expansion may be selected. A position between the position (0, 0) of the first basic glyph 110 and the position (m, 0) of the second basic glyph 120 may be selected as the position of the necessary glyph. If the corresponding position is selected, a transversely expanded glyph corresponding to the selected position may be generated by an interpolation operation using the first and second basic glyphs 110 and 120.

Similarly to this, when selecting a position of a necessary glyph for longitudinal expansion, a position between the position (0, 0) of the first basic glyph 110 and the position (0, n) of the third basic glyph 130 may be selected. Also, a longitudinally expanded glyph corresponding to the selected position may be generated by an interpolation operation using the first and third basic glyphs 110 and 130. Similarly to this, a transversely and/or longitudinally expanded glyph corresponding to a position between the position (0, 0) of the first basic glyph 110 and the position (m, n) of the fourth basic glyph 120 may be generated.

One representative coordinate is described for one basic glyph in the embodiment of FIG. 3, but embodiments of the present invention are not limited thereto. For example, in order to realize one glyph, a plurality of pieces of coordinate information may be included for each glyph, and an operation may be performed on corresponding coordinate information of two or more basic glyphs to perform an interpolation operation to generate an interpolation glyph.

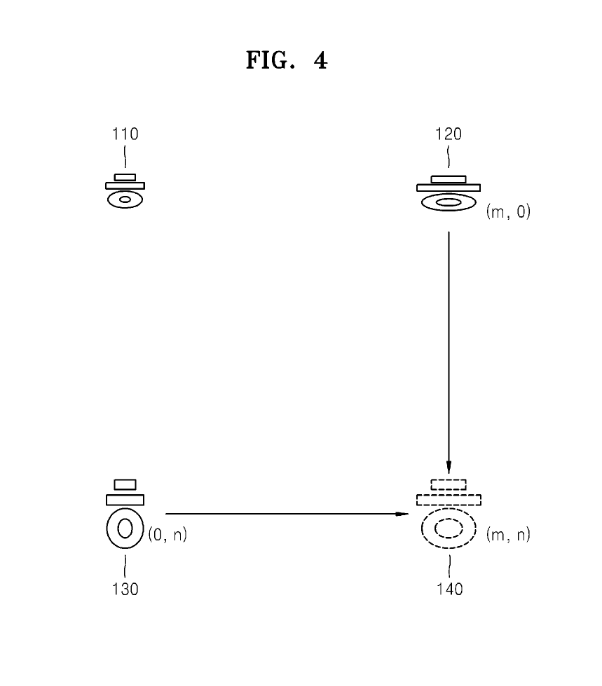

FIG. 4 is a view illustrating an interpolation operation for generating various shapes of glyphs, according to an embodiment of the present invention. In the embodiment of FIG. 4, all glyphs of one grapheme are generated by using only a basic glyph and transversely expanded and longitudinally expanded basic glyphs.

As shown in FIG. 4, for example, three basic glyphs are provided to correspond to grapheme “ [symbol] ”, a first basic glyph is a basic glyph, a second basic glyph 120 is a transversely expanded glyph of the basic glyph, and a third basic glyph 130 is a longitudinally expanded glyph of the basic glyph. (m+1)*(n+1) glyphs may be generated by an interpolation operation using the three basic glyphs.

When generating a necessary glyph by using three basic glyphs, the transversely expanded glyph of the first basic glyph 110 may be generated by interpolating the first and second basic glyphs 110 and 120. Also, the longitudinally expanded glyph of the first basic glyph 110 may be generated by interpolating the first and third basic glyphs 110 and 130. All of the first, second, and third basic glyphs 110, 120, and 130 may be interpolated to generate the transversely and/or longitudinally expanded glyph of the first basic glyph 110. The transversely and longitudinally expanded glyph of the first basic glyph 110 may correspond to the fourth basic glyph in the above-described embodiment. Also, only the second and third basic glyphs 120 and 130 may be interpolated to generate a glyph having the same shape as the fourth basic glyph in FIG. 4.

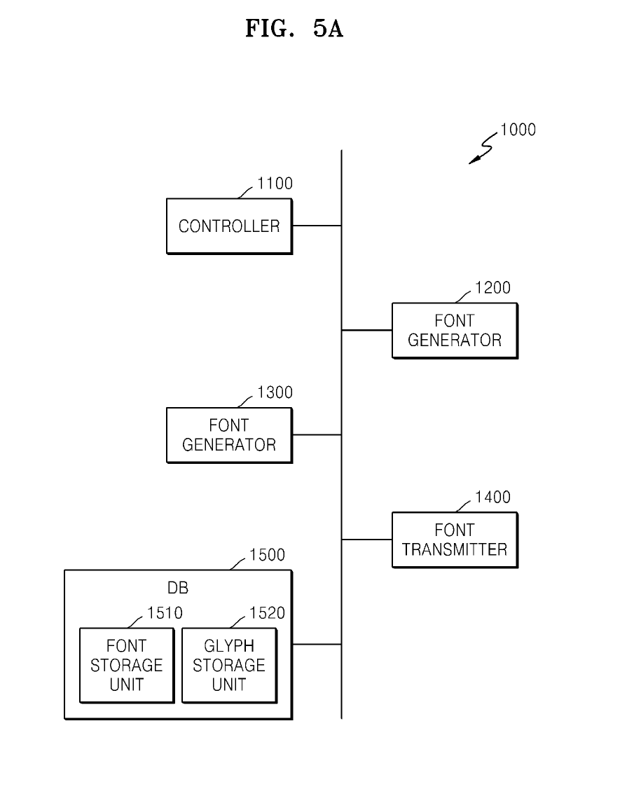

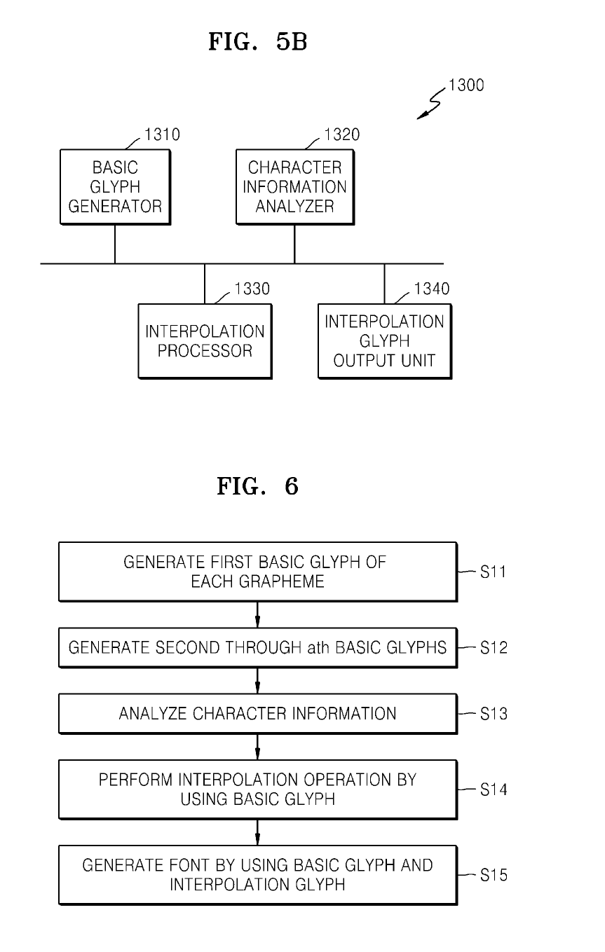

FIGS. 5A and 5B are block diagrams illustrating an apparatus 1000 for generating a font according to an embodiment of the present invention. The block diagrams of FIGS. 5A and 5B illustrate various types of functions for generating a glyph in the apparatus 1000. The various types of functions of FIGS. 5A and 5B may be realized as apparatuses or software.

As shown in FIG. 5A, the apparatus 1000 includes a controller 1100, a font generator 1200, a glyph generator 1300, a font transmitter 1400, and a database (DB) 1500. The DB 1500 may include a font storage unit 1510 and a glyph storage unit 1520.

The controller 1100 controls an overall operation of a system of the apparatus 1000. For example, the controller 1100 may control operations of various types of other function blocks of FIG. 5A, control transmissions of information between the function blocks, generate a basic glyph, generate a glyph through an interpolation operation performed between basic glyphs, and generate a font by using the generated glyph.

The font generator 1200 may generate one or more fonts for expressing various types of languages and respectively generate fonts by using a plurality of glyphs. As described above, if a character is expressed according to a grapheme combination, a font may be generated by using an additional glyph according to each grapheme. Also, a plurality of glyphs may exist according to combination forms of graphemes in a character, and thus each of a plurality of glyphs may be differently applied to one grapheme to generate a font.

The glyph generator 1300 may generate glyphs according to the above-described embodiments. For example, a plurality of basic glyphs may be pre-generated and stored in a system (or in the glyph storage unit 1520) to correspond to one grapheme. If glyphs having different shapes are required to generate a font, the glyph generator 1300 may perform an interpolation operation using basic glyphs based on input information of a user and generate glyphs (interpolation glyphs) having different shapes from the basic glyphs according to a result of the interpolation operation. The pre-generated basic glyphs may include a first basic glyph having a basic shape of one grapheme, a second basic glyph having a transversely expanded shape of the basic shape, a third basic glyph having a longitudinally expanded shape of the basic shape, and a fourth basic glyph having a transversely and/or longitudinally expanded shape of the basic shape. Alternatively, according to another embodiment, as described above, only first through third basic glyphs may be generated to correspond to each grapheme, or a different number of basic glyphs (for example, a larger number of basic glyphs) may be generated.

The glyph generator 1300 may perform an interpolation operation on at least two of a plurality of basic glyphs to generate various shapes of glyphs as shown in FIG. 2. Basic glyphs may be stored in the glyph storage unit 1520, and the glyph generator 1300 may perform the interpolation operation by using the basic glyphs stored in the glyph storage unit 1520. The font generator 1200 may generate a font by using the basic glyphs stored in the glyph storage unit 1520 and interpolation glyphs generated by the glyph generator 1300. The font generated by the font generator 1200 may be stored in the font storage unit 1510.

The font transmitter 1400 may transmit the font to a font display apparatus (not shown) through an external interface (for example, a network such as the Internet or the like). If the font is transmitted based on a web, the apparatus 1000 may be a web font server, and the font display apparatus that receives the font through the web may be a web client. The apparatus 1000 may transmit a pre-generated font to the web client or may generate the corresponding font in real time and transmit the font to the web client if a request for the font is received from the web client.

The apparatus 1000 according to the present embodiment generates various shapes of glyphs by using only a very small number of glyphs and thus may reduce a time taken to form a font. Therefore, a pre-stored font may be efficiently generated by using only a small number of glyphs, and even if forming and transmitting of the font is requested in real time, the font may be generated and provided to the web client without any large delay.

FIG. 5B is a block diagram illustrating the glyph generator 1300 of FIG. 5A, according to an embodiment of the present invention. As shown in FIG. 5B, the glyph generator 1300 includes a basic glyph generator 1310, a character information analyzer 1320, an interpolation processor 1330, and an interpolation glyph output unit 1340.

The basic glyph generator 1310 may generate a plurality of basic glyphs corresponding to each character or each grapheme as described above, for example, may generate one basic shape glyph and transversely and/or longitudinally expanded basic glyphs of the basic shape glyph. The character information analyzer 1320 may analyze characters that will be realized by a font when realizing the corresponding font and information of graphemes included in each of the characters to select glyphs that will be applied to a corresponding character or grapheme.

The interpolation processor 1330 performs an interpolation operation to generate a glyph for expressing a corresponding character or grapheme based on the analyzed character information. The interpolation operation may be based on an interpolation operation using at least two of a plurality of pre-generated basic glyphs. A glyph interpolated as described above is provided to the font generator 1200 through the interpolation glyph output unit 1340, and the font generator 1200 generates a font by using various shapes of glyphs.

FIG. 6 is a block diagram illustrating a method of operating a font generating apparatus, according to an embodiment of the present invention. In FIG. 6, a character is expressed according to a combination of graphemes, and a font is realized by using a glyph that is generated to correspond to each grapheme.

As shown in FIG. 6, in operation S11, a first basic glyph of each grapheme is generated. The first basic glyph corresponds to a basic shape glyph of a corresponding grapheme. In operation S12, second through a^{th} basic glyphs related to the first basic glyph are generated. The number of generated glyphs may be 3, 4, or more. For example, second through fourth basic glyphs related to the first basic glyph may be generated. Among these, the second basic glyph may be a transversely expanded glyph of the first basic glyph, the third basic glyph may be a longitudinally expanded glyph of the first basic glyph, and the fourth basic glyph may be a transversely and/or longitudinally expanded glyph of the first basic glyph.

In operation S130, each character information is analyzed when forming a font. The analysis operation of the character information may perform an operation of analyzing graphemes included in a corresponding character, an applied position of each of the graphemes in the corresponding character, etc. Therefore, glyphs of each of the graphemes included in the corresponding character may be selected and may be glyphs included in first through fourth basic glyphs or glyphs into which the first through fourth basic glyphs are modified.

In operation S14, an interpolation operation is performed by using basic glyphs based on the above-described analysis operation. The interpolation operation may be performed based on the embodiment of FIG. 2 to generate various shapes of glyphs by using basic glyphs. If interpolation glyphs are generated as described above, a font is completely generated by using the basic glyphs and the interpolation glyphs in operation S15.

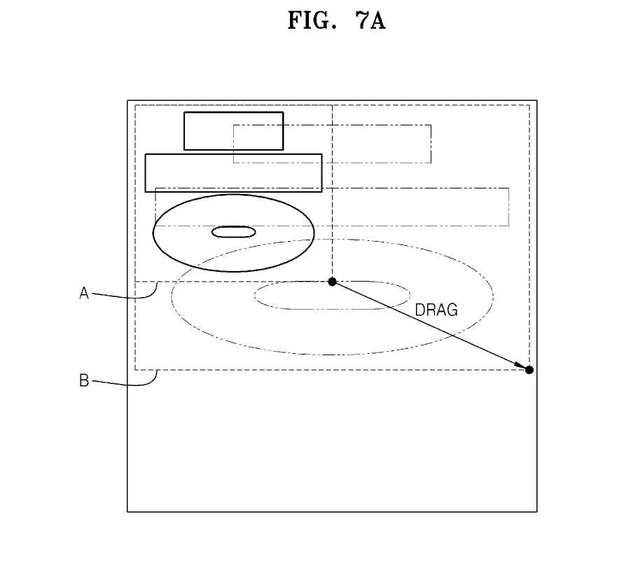

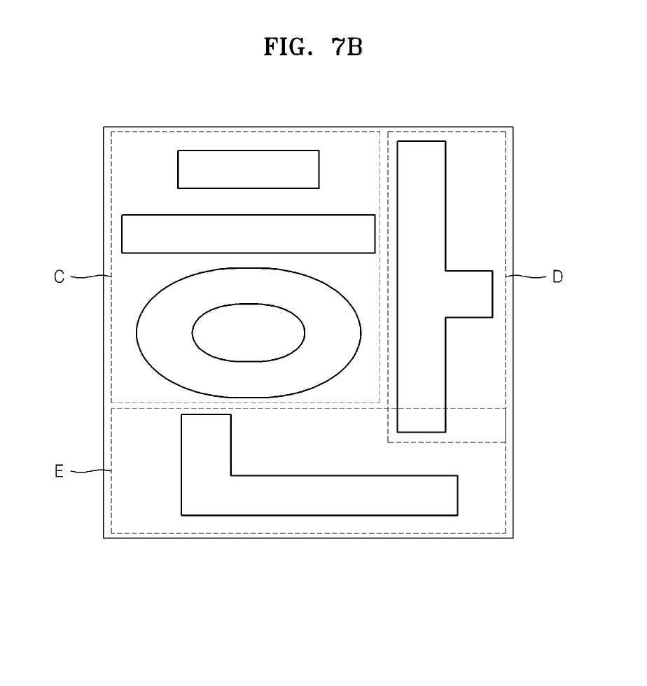

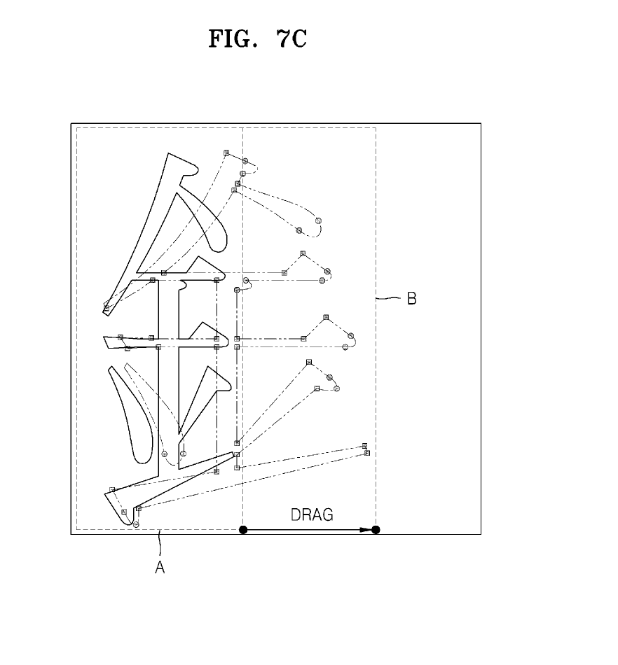

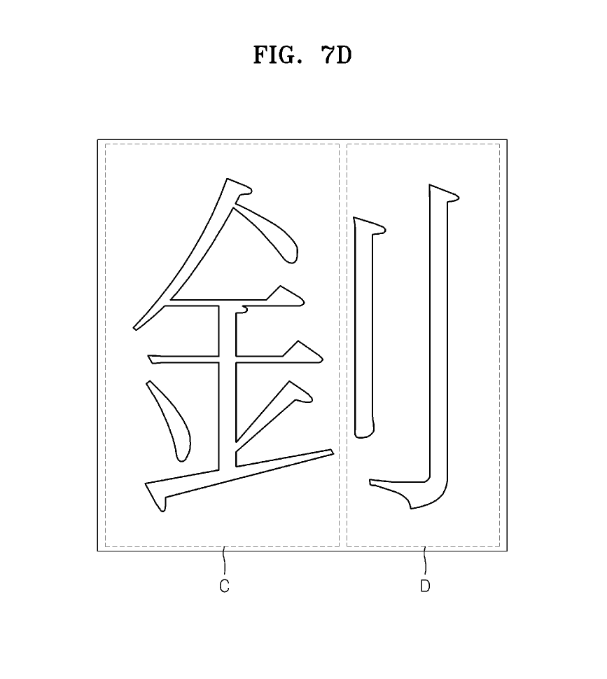

FIGS. 7A through 7D are views illustrating a user interface by using a bounding box provided to generate an interpolation glyph, according to an embodiment of the present invention. FIGS. 7A and 7B illustrate a glyph of the grapheme “ [symbol] ” of Hangul, and FIGS. 7C and 7D illustrating a glyph of the grapheme “ [symbol] ” which is a Chinese character that means “gold”.

As shown in FIG. 7A, one of a plurality of pre-stored basic glyphs is selected by a user to generate an interpolation glyph. The selected basic glyph may be defined as a master glyph, and the master glyph is expressed in a first bounding box A according to the selection.

The user selects a border or a vertex of the first bounding box A and drags the selected border or vertex to adjust the bounding box A. The bounding box adjusted by the user may be referred to as a second bounding box B, and information (for example drag information) input by the user is analyzed in a system. In FIG. 7A, the second bounding box B is formed by transversely and longitudinally expanding the first bounding box A, and thus a shape of the glyph of the grapheme “ [symbol] ” is modified to correspond to the second bounding box B. The glyph whose shape is modified may be stored as an interpolation glyph according to a storage command of the user or the like, and thus a glyph is further generated and stored in the system.

The selected master glyph and at least one basic glyph may be selected to generate an interpolation glyph, and an interpolation operation may be performed by using the master glyph and the selected basic glyph. One glyph may be formed of a plurality of coordinates and thus include information about the plurality of coordinates. Also, a weight is applied to corresponding coordinate information of a plurality of glyphs (including a master glyph and a basic glyph) to perform an operation in order to perform an interpolation operation. In addition, an interpolation glyph having new coordinate information calculated according to a result of the operation is generated. In FIG. 7, the master glyph and the interpolation glyph may substantially have the same thickness, and the interpolation glyph may have a shape that is transversely and longitudinally expanded in comparison to the master glyph.

FIG. 7B illustrates a font of the word “ [symbol] ” as an example of a combination glyph. In order to form the character “ [symbol] ”, a glyph of the graphemes “ [symbol] ”, “ [symbol] ”, and “ [symbol] ” may be selected as a master glyph, and the master glyph may be expressed in a bounding box of each of the graphemes.

For example, a first bounding box C of the grapheme “ [symbol] ”, a second bounding box D of the grapheme “ [symbol] ”, and a third bounding box E of the grapheme “ [symbol] ” may be expressed, and the user may realize a font through a drag input of each bounding box. Information generated according to the drag input of each bounding box may be analyzed, each grapheme may be modified into a shape such as a transversely expanded and/or reduced shape, a longitudinally expanded and/or reduced shape, a transversely and longitudinally expanded and/or reduced shape, or the like according to a result of the drag input.

FIG. 7C illustrates one of a plurality of basic glyphs of the grapheme “ [symbol] ” which is a Chinese character that is selected and expressed as a master glyph. Similarly to the embodiment of FIG. 7A described above, the selected master glyph is expressed in a first bounding box A, and the user selects a border or vertex of the first bounding box A and drags the selected border or vertex to adjust a bounding box. For example, a longitudinally expanded basic glyph may be selected as a master glyph in the first bounding box A, and the first bounding box A may be adjusted as a second bounding box B through a drag operation. Therefore, a transversely expanded and longitudinally reduced interpolation glyph of the master glyph may be generated.

FIG. 7D illustrates a font of the Chinese character “ [symbol] ” (which means “iron”?) that is realized as an example of a combined glyph. In order to form the Chinese character “ [symbol] ”, glyphs of the graphemes “ [symbol] ” and “ [symbol] ” may be selected as master glyphs, and the master glyphs may be expressed in a bounding box of each of the graphemes. For example, a first bounding box C and a second bounding box C are generated, the graphemes “ [symbol] ” and “ [symbol] ” are respectively expressed in the first bounding box C and the second bounding box D. Drag information of the user with respect to each bounding box may be analyzed to change shapes of the master glyphs “ [symbol] ” and “ [symbol] ”. As a result, a font formed of glyphs having different shapes may be realized.

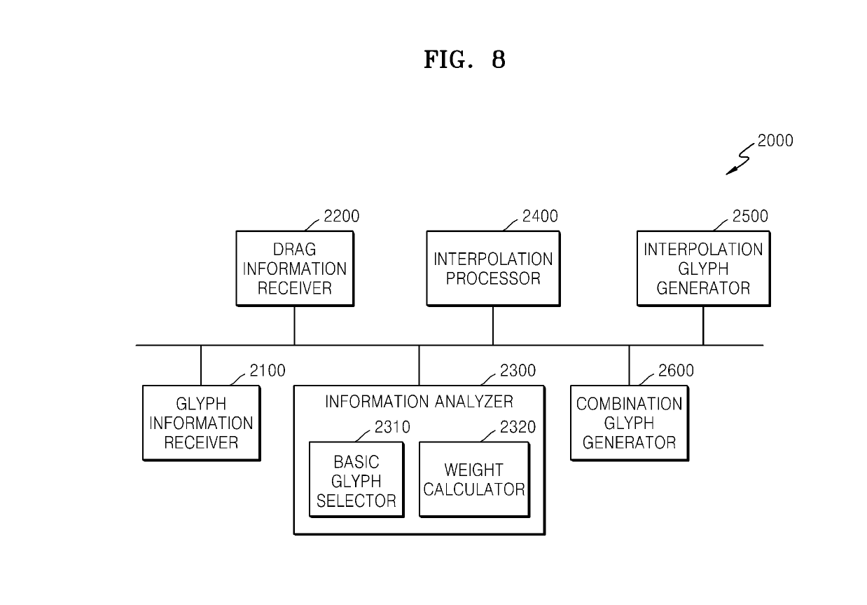

FIG. 8 is a block diagram illustrating an apparatus for generating a font, according to another embodiment of the present invention. For example, a glyph generator 2000 is illustrated as an element of the apparatus in FIG. 8, and other elements as described above with reference to FIG. 5A may be further included in the apparatus.

The glyph generator 2000 includes a glyph information receiver 2100, a drag information receiver 2200, an information analyzer 2300, an interpolation processor 2400, an interpolation glyph generator 2500, and a combination glyph generator 2600. Also, the information analyzer 2300 may include a basic glyph selector 2310 and a weight calculator 2320. In FIG. 8, elements of the apparatus for generating glyphs are illustrated as different function blocks. At least two of various types of elements of FIG. 8 may be realized as one function block, one function block may be divided into two or more function blocks, or the various types of elements of FIG. 8 may be realized as software.

The glyph information receiver 2100 receives information of a glyph selected by a user. For example, two or more basic glyphs of each glyph may be pre-generated and pre-stored in a DB. If the user wants to generate an interpolation glyph of a preset glyph, information of one selected from a plurality of basic glyphs included in the glyph may be received. One basic glyph is output as a master glyph in a bounding box according to the selected information.

The user may drag a bounding box to generate a changed bounding box, and the drag information receiver 2200 receives information related to the drag operation of the user. For example, as described above, the user may select and drag a border or vertex of the bounding box to change the bounding box. A size of a first bounding box may be determined according to a shape (a basic shape, a transversely expanded shape, a longitudinally expanded shape, a transversely and/or longitudinally expanded shape, etc.) of a master glyph that is initially selected. Also, information of a second bounding box, which has a shape adjusted according to information (for example, coordinate information realizing the first bounding box) of the first bounding box and a drag operation of the user, may be received as drag information.

The information analyzer 2300 may analyze the drag information and output a result of the analysis. For example, the basic glyph selector 2310 may analyze the drag information to select a basic glyph necessary for an interpolation operation. If a basic glyph is selected as a master glyph, and the user transversely expands the first bounding box, besides the master glyph, a transversely expanded basic glyph may be required for an interpolation operation, and the basic glyph selector 2310 may output an analysis result indicating this. The weight calculator 2320 calculates and outputs a weight for the interpolation operation. For example, if the second bounding box adjusted by the user is adjusted to a similar shape to the transversely expanded basic glyph, the transversely expanded basic glyph has a relatively greater weight than the master glyph.

The interpolation processor 2400 performs the interpolation operation according to the above-described information analysis result. For example, the interpolation processor 2400 performs the interpolation operation by using coordinate information included in the master glyph, coordinate information included in the selected basic glyph, and the calculated weight and outputs a result of the interpolation operation (for example, coordinate information calculated according to the interpolation operation). The interpolation glyph generator 2500 may generate an interpolation glyph having a shape that is formed according to the result of the interpolation operation, and the combination glyph generator 2600 may combine two or more glyphs generated through the above-described process to generate a combination glyph. The interpolation glyph generator 2500 and the combination glyph generator 2600 are illustrated as different function blocks. However, as described above, such a function may be performed through the same function block according to a realization of a system.

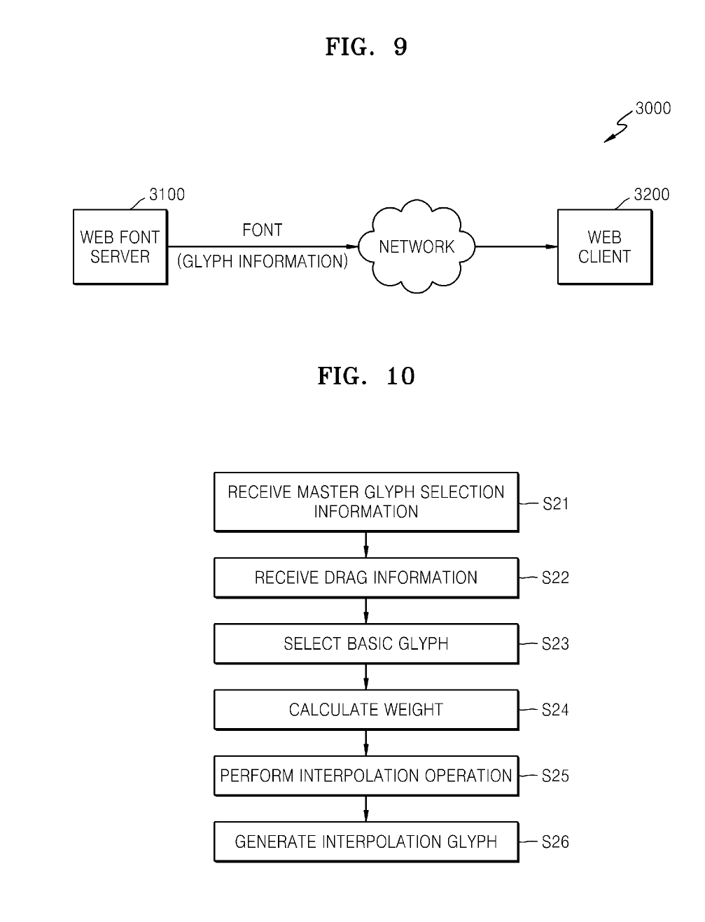

FIG. 9 is a block diagram illustrating a web font system 3000 according to an embodiment of the present invention. As shown in FIG. 9, the web font system 3000 includes a web font server 3100 and a web client 3200. The web font server 3100 may include a font generating apparatus as in the above-described embodiment. The web font server 3100 may communicate with the web client 3200 through a network to provide a font, a subset font, or the like. Also, when transmitting the font, the web font server 3100 may transmit information about a glyph constituting the font along with the font.

According to an embodiment of the present invention, the total number of glyphs necessary for realizing a font may be considerably reduced. Therefore, a total amount of transmitted information may be reduced when transmitting the font through a network.

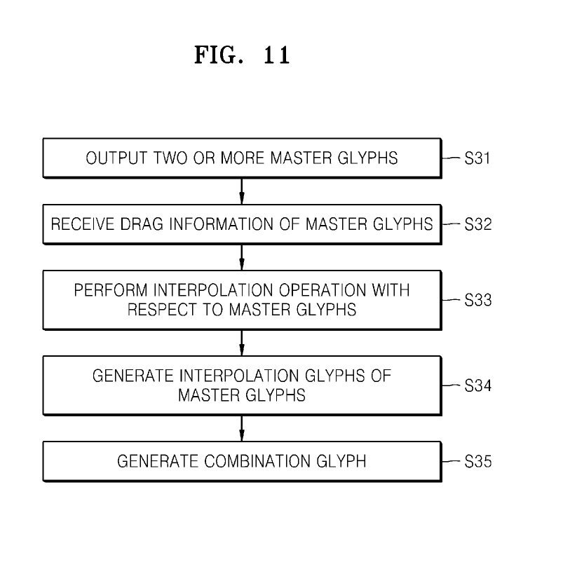

FIG. 10 is a flowchart illustrating a method of generating a glyph, according to another embodiment of the present invention. As shown in FIG. 10, a user may select a glyph that will be used for a font, if the selected glyph is expressed in a bounding box, drag the glyph to change a shape of the glyph, and store the glyph having the changed shape. If one grapheme is determined, one of a plurality of basic glyphs included in the grapheme is selected as a master glyph to receive information about the selected master glyph in operation S21.

In operation S22, the master glyph is expressed in a bounding box, and the user drags the bounding box to receive drag information. In operation S23, the drag information is analyzed to select one or more basic glyph necessary for an interpolation operation. In other words, besides the master glyph, two or more basic glyphs (or three basic glyphs) may be further stored in a system, and one or more basic glyphs that will be used for the interpolation operation may be selected according to the drag information. In operation S24, the drag information is analyzed to calculate weights of a plurality of basic glyphs (including the master glyph) that will be used for the interpolation operation. In operation S25, the interpolation operation is performed by using the basic glyphs and the calculated weights. In operation S26, coordinate information is generated according to a result of the interpolation operation, and an interpolation glyph is generated by using the coordinate information.

FIG. 11 is a flowchart illustrating a method of generating a glyph, according to another embodiment of the present invention. In FIG. 11, two or more graphemes are combined to generate a font of one character.

Two or more graphemes may be combined to realize one character. Therefore, in operation S31, a user selects two or more master glyphs to respectively output the master glyphs in bounding boxes. The user drags the bounding boxes to change respective glyphs, and thus drag information of the user is received in operation S32.

In operation S33, the drag information of the bounding boxes of the master glyphs is analyzed to perform an interpolation operation according to a result of the analysis. In operation S34, interpolation glyphs of the master glyphs are generated. If the user re-adjusts the bounding boxes, the interpolation operation may be re-performed to generate an interpolation glyph having a changed shape. The user may check the output interpolation glyph to determine whether the interpolation glyph is to be stored. In operation S35, the output interpolation glyph is stored as a new glyph to generate the corresponding interpolation glyph as a final combination glyph.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of generating a font, the method comprising:
generating a first basic glyph as a basic shape of a character or a grapheme;
generating second through a^{th} (wherein a is an integer greater than or equal to 2) basic glyphs to which at least one of a transversely expanded shape of the basic shape and a longitudinally expanded shape of the basic shape is applied;
performing an interpolation operation by using at least two of the first through a^{th} basic glyphs to generate an interpolation glyph having a different shape from the first through a^{th} basic glyphs; and
generating a font by using the first through a^{th} basic glyphs and the interpolation glyph.

2. The method of claim 1, further comprising:
analyzing information of characters of which the font is realized,
wherein at least two of the first through a^{th} basic glyphs are selected according to a result of the analyzing to perform the interpolation operation in order to generate the interpolation glyph.

3. The method of claim 1, wherein the second through a^{th} basic glyphs comprise second through fourth basic glyphs,
wherein the second glyph is a transversely expanded glyph of the basic shape, the third basic glyph is a longitudinally expanded glyph of the basic shape, and the fourth basic glyph is at least one of a transversely expanded glyph of the basic glyph and a longitudinally expanded glyph of the basic glyph.

4. An apparatus for generating a font, the apparatus comprising:
a font generator which generates a font by using a plurality of glyphs; and
a glyph generator which pre-generates a plurality of basic glyphs for realizing the font and performs an interpolation operation with respect to two basic glyphs selected from the plurality of basic glyphs to generate interpolation glyphs having different shapes from the basic glyphs,
wherein the font generator generates the font by using at least one of the pre-generated basic glyphs and the interpolation glyphs generated by the interpolation operation.

5. The apparatus of claim 4, wherein the glyph generator generates at least first through third basic glyphs,
wherein the first basic glyph is a glyph corresponding to a basic shape of a character or a grapheme, the second basic glyph is a transversely expanded glyph of the basic shape, and the third basic glyph is a longitudinally expanded glyph of the basic shape.

6. The apparatus of claim 4, wherein the glyph generator comprises:
a character information analyzer which analyzes information of characters of which the font is realized; and
an interpolation processor which selects at least two basic glyphs according to a result of the analyzing to perform the interpolation operation.

7. A computer-readable storage medium that stores a program for performing a function of the apparatus of claim 4.

8. A web font server comprising the apparatus of claim 4.
